(19) United States
(12) Patent Application Publication
(10) Pub. No.: US 2018/0169689 A1
(43) Pub. Date: Jun. 21, 2018

(54) PRESERVATION INSTALLATIONS FOR VEHICLE BODIES, METHOD FOR THE PRESERVATION OF A VEHICLE BODY AND VEHICLE BODY

(71) Applicant: IPR - INTELLIGENTE PERIPHERIEN FÜR ROBOTER GMBH, Schwaigern (DE)

(72) Inventors: Fredy DOLL, Achern (DE); Claus DREHER, Gozo (MT)

(21) Appl. No.: 15/735,349

(22) PCT Filed: Jun. 12, 2015
(86) PCT No.: PCT/EP2015/063215

§ 371 Date: Dec. 11, 2017

(51) Int. Cl. B05B 13/04; B05B 13/06; B05B 9/04; B05C 7/04; B05B 7/24; B05D 7/14

(52) U.S. Cl. CPC B05B 13/0452; B05B 13/0627; B05B 9/0423; B05C 7/04; B05D 2501/10; B05B 7/2491; B05D 7/14; B05B 13/0431; B05B 9/0406

(57) ABSTRACT

In order to preserve vehicle bodies, a common plant is used, which plant is configured both for flooding and for spraying. The plant makes use of a common feed system and is operated with the same preservative for the spraying and the flooding.

### FIELD OF APPLICATION AND PRIOR ART

The invention relates to a preservation plant for vehicle bodies according to the preamble of claim 1, to a method for preserving a vehicle body according to the preamble of claim 10, and to a vehicle body preserved by means of this method according to the preamble of claim 13.

It is well known from the prior art to provide vehicle bodies with a preservative in order to prevent corrosion. The preservative used for this purpose is usually a waxy preservative which is usually introduced into cavities of the vehicle and applied to surfaces of the vehicle in a largely automated process.

In particular two methods have become prevalent for this purpose. In flooding, the wax is applied in a liquid form and introduced in particular into cavities. Excess wax flows back out of these cavities such that only a layer covering the surfaces of the cavity remains. By contrast, in spraying, the preservative is output together with atomizing air in the form of a spray jet.

These methods are usually used separately. Most automotive manufacturers have committed themselves to one method at least in relation to the body within the meaning of this invention, this being understood as being just the vehicle body without doors and flaps. They operate plants provided for this purpose, which are likewise designed for one of these methods and are operated with a preservative that is respectively optimized for the method.

However, as a result of a unitary method being used for the vehicle body, advantages relating to the respectively other method cannot be exploited.

### Problem and Solution

The invention addresses the problem of providing an improved method for preserving vehicle bodies. The invention also addresses the problem of providing a plant suitable for this purpose.

The problem is solved by a preservation plant as claimed in claim 1.

The preservation plant is configured for discharging a waxy preservative into cavities and/or onto surfaces of a vehicle body. It comprises, in accordance with generic preservation plants, at least one storage tank for the preservative, a discharging system for dispensing the preservative, and a feed pump for feeding the preservative from the storage tank to the discharging system.

According to the invention, the preservation plant comprises at least two separate discharging systems for dispensing the preservative. A first discharging system is configured to discharge the preservative in a liquid form (flooding wax). A second discharging system is configured to discharge the preservative in an atomized form together with atomizing air (spray wax).

The preservation plant according to the invention is accordingly configured for both methods. A common plant, which allows the preservation of a vehicle body located in a defined position, therefore comprises at least two discharging systems, which are provided for flooding, for the one part, and for spraying, for the other part.

This makes it possible to preserve the vehicle body with appropriate methods in each case. Cavities can thus be preserved for example by flooding, while in particular relatively small surface portions that are prone to corrosion, in particular outside cavities, can be preserved by spraying.

The preservation plant provided for this purpose has the two discharging systems in spatial proximity such that they can preferably be used at the same time.

The preservation plant may comprise a common storage tank for supplying the first discharging system and the second discharging system.

The preservation plant may furthermore comprise a common feed pump for feeding the preservative from the storage tank to the first discharging system and to the second discharging system.

The use of a common storage tank for supplying both discharging systems and/or the use of a common feed pump, which does not have to be the only feed pump, however, results in a simplified system with fewer subcomponents.

The preservation plant may have a loop in which the common feed pump is provided and which has an inlet and an outlet, which are both connected to the storage tank. At least a first supply line for supplying the first discharging system and a second supply line for supplying the second discharging system may branch off from the loop.

The loop permanently provides a sufficient flow of preserving wax for the two discharging systems. The wax is fed from the storage tank into the loop, in particular by means of a feed pump. Wax that is not carried onward into the supply lines passes back into the storage tank through the loop. In the loop, a heating device can additionally be provided in order to heat the wax to the temperature necessary for processing. However, the storage tank can also already permanently provide this temperature by way of a heating device. Furthermore, heating devices can also be provided in the supply lines that branch off from the loop, in order to achieve an optimum temperature for the particular discharging technique (flooding, spraying).

Valves may be provided between the loop and the supply lines in order to interrupt the inflow of preservatives to the discharging systems in phases or to control the quantity of preservative delivered.

At least one supply line may have a further feed pump for supplying the associated discharging system.

The use of additional feed pumps in at least one of the supply lines makes it possible to adapt the discharging pressure to the particular discharging technique. High pressures are advantageous in particular for spraying, and so in particular the supply line to the second discharging system can have such a further feed pump. The common feed pump, in particular in the loop, may also suffice for flooding. However, a further feed pump is conceivable here, too.

For example, the feed pump may be designed to generate a pressure of 10 bar to 20 bar in the loop on the other side of the feed pump. A further feed pump which is assigned to spraying increases the pressure here subsequently, for example to about 100 bar-180 bar for the purpose of discharging with atomizing air.

In a variant system, only a central feed pump is used. An optionally necessary pressure adaptation for the discharging systems takes place by way of respectively associated pressure regulators.

The first discharging system may comprise a flood bar for positioning at a cavity to be flooded, having at least one outlet for the preservative.

Such a flood bar has one or preferably a plurality of outlets for the preservative and is adapted to openings in the body with regard to the arrangement of the plurality of outlets. In addition, the flood bar can also have one or more inlets in order to receive excess preservative from the cavity.

The second discharging system may comprise at least one spray nozzle which is supplied with atomizing air and preservative.

The spray nozzle serves to dispense the preservative in an atomized form. Besides a supply line for the preservative itself, it is preferably additionally supplied with atomizing air through a separate line. This atomizing air breaks the preservative up into small droplets which bring about a homogeneous layer thickness on application.

A system with additional atomizing air is not absolutely necessary, however. By way of suitable nozzles, atomization can also be achieved without any additional air supply. While the preservative, when atomized with air, is supplied with air from a mixing chamber provided for this purpose at between 100 bar and 180 bar, lower pressures are generally sufficient for atomization without air, for example between 2 bar and 50 bar, preferably between 5 bar and 20 bar.

The flood bar and/or the spray nozzle may be configured to be permanently or temporarily attached to a robot arm.

Preferably, the flood bar and/or the spray nozzle are intended to be attached to a robot arm. In particular in the case of flood bars, it may be expedient to provide temporary attachment, i.e. a coupling system by means of which the robot can automatically exchange the flood bar for a different flood bar.

As a result of only temporary coupling, controllable by the robot itself, to the flood bar and the spray nozzle, a single robot suffices for operating both discharging systems.

The preservation plant has two robots for the simultaneous preservation of the body by means of the flood bar and by means of the spray nozzle.

The use of two robots, which execute flooding and spraying at the same time, results in short cycle times.

The problem is also solved by a method for preserving a vehicle body as claimed in claim 10.

In this case, the vehicle body is delivered to a preservation plant of the described type. By means of the latter, the vehicle body is preserved partially by flooding and partially by spraying.

As already explained, it is particularly advantageous for cavities to be preserved by flooding, while other surfaces are preserved at least in part by spraying.

Both the flooding and the spraying may take place with a preserving wax which is flowable and sprayable at 30°.

In principle, the use of different preservatives, in particular preserving waxes, is also possible, in particular when respectively adapted units for adapting the pressure or the temperature are provided in the supply lines.

However, the use of a common preserving wax that is flowable and sprayable at 30° C. simplifies the structure, since the lines of the used plant and of the storage tank can be embodied together and, depending on the preservative, it is also possible for heating devices assigned specifically to the individual discharging systems to be dispensed with. A preserving wax that is useable for flooding and spraying at the same temperature of 30° C. is known under the name ANTICORIT DS 329 DE from Fuchs Europe Schmierstoffe GmbH in Mannheim.

The actual temperature to which the preservative is heated for the purpose of discharging is preferably between 20° C. and 60° C., particularly preferably between 40° C. and 60° C.

The problem addressed by the invention is also solved by a vehicle body as claimed in claim 13.

Such a body, which has been treated with regard to corrosion resistance partially by spraying and partially by flooding, affords advantages in terms of the costs required therefor. Furthermore, as a result of the adapted processes, it is also possible for less preservative to be used, thereby making it possible to reduce the mass of the body.

### BRIEF DESCRIPTION OF THE DRAWINGS

Further advantages and aspects of the invention can be gathered from the claims and from the following description of a preferred exemplary embodiment of the invention, which is explained in the following text with reference to the FIGURE.

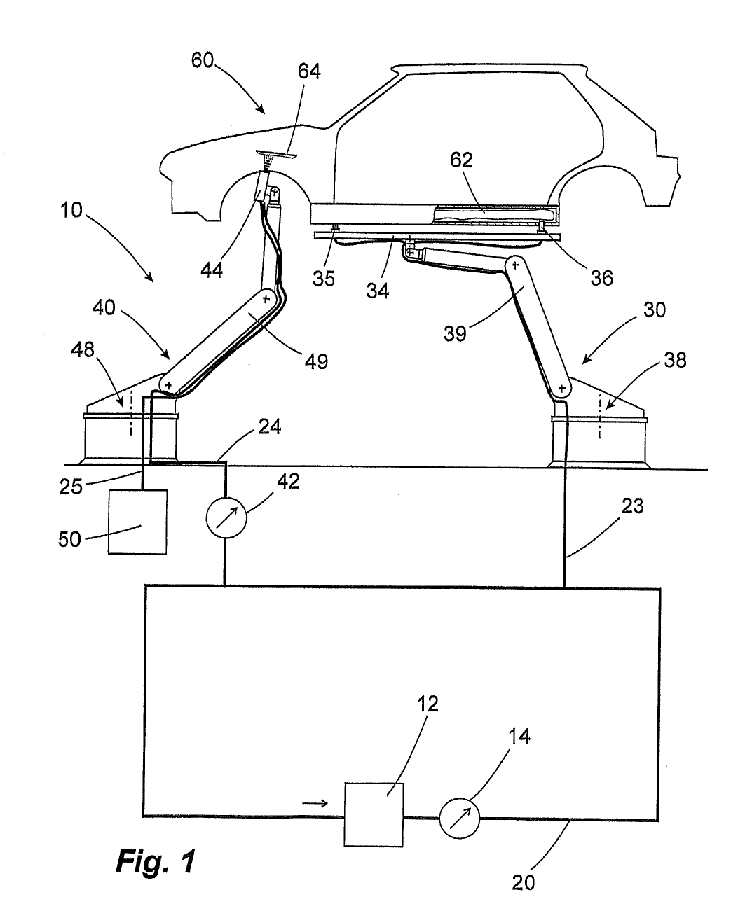

This FIG. 1 shows a preservation plant according to the invention with a vehicle body introduced therein.

### DETAILED DESCRIPTION OF THE EXEMPLARY EMBODIMENT

FIG. 1 schematically shows a preservation plant 10 according to the invention for preserving a vehicle body 60. This vehicle body 60 has cavities 62 and surfaces 64 which are intended to be coated appropriately with a preservative in order to reduce the corrosion tendency. These may be for example sills of the body or attachment regions for further components such as an engine, transmission, shock absorber or the like.

The preservation plant 10 used has two separate discharging systems 30, 40. The discharging system 30 is a flooding wax discharging system and has a flood bar 34 with a wax outlet 36 for dispensing the wax in a liquid form. The flood bar 34 is coupled to a robot arm 39 of a robot 38 which can therefore position the flood bar properly after the body has been delivered to the preservation plant, specifically such that the wax outlet 36 projects into the cavity 62 through an opening.

The second discharging system 40 is a discharging system for spraying. It has a spray device 44 which is likewise attached to a robot arm 49 of a robot 48 and is thus movable in a flexible manner.

The two discharging systems 30, 40 each have supply lines 23, 24, by means of which they are connected to a loop 20. In the case of the discharging system 40, the spray device 44 is additionally connected by means of an air line 25 to a compressor 50, by way of which atomizing air is supplied to the spray device 44.

The two supply lines 23, 24 are connected to a loop 20, in which a storage tank 12 and a feed pump 14 are additionally provided. The feed pump 14 ensures that the wax heated to about 30° C., in the present case ANTICORIT DS 329 DE, circulates in the loop 20 under pressure. As soon as the discharging systems 30, 40 are ready to discharge by respective positioning, valves (not illustrated here) that are assigned to the supply lines can be opened such that the supply lines 23, 24 are supplied with preservative.

In the case of the supply line 24 of the spray wax system 40, an additional feed pump 42 is provided in order to further increase the pressure with respect to the loop 20 and thus to achieve the desired spray behavior at the spray device 44. The pressure level, brought about by the feed pump 14, in the loop 20 can be for example 20 bar, while, for the purpose of atomization, the pressure in the supply line 24 is raised to 160 bar by the feed pump 42. This pressure is suitable for the air atomization of preserving wax.

In the case of the flooding wax discharging system 30, it is not necessary to raise the pressure and so a further feed pump is not provided here.

In operation, the bodies 60 are delivered to the preservation plant 10 in a cycled manner. As soon as the processing position has been reached, the preservation by means of the discharging systems 30, 40 starts simultaneously or one after the other. Via the flood bars 34 and the wax outlet 36, the preserving wax is delivered into the cavity 62 and forms a protective layer covering the walls there. Excess wax runs back out of the cavity 62 or is pumped out actively. Via the spray device 44, preserving wax is applied in an atomized form such that it covers the surfaces 64 toward which the spray device is directed.

The preserving wax can harden in situ, wherein this hardening can be due in particular to physical effects.

The illustrated preservation plant thus makes it possible to preserve the vehicle body 60 in an ideally suitable manner in each case, wherein, preferably, the respective preservation steps with respect to the cavities 62 and the surface 64 are carried out at the same time.

In the system illustrated, a single storage tank is used, which thus also provides only one preservative for flooding and spraying. In alternative designs, it would also be possible to use two storage tanks, which each contain different preservatives for spraying and flooding.

In a deviation from the described plant, it is also possible to use a plant in which a pressure which is sufficient for flooding and for spraying already prevails in the loop. This pressure, which is generated by the central feed pump, can be for example 160 bar. The supply lines can then each be provided with pressure regulators in order to suitably reduce the pressure for the discharging systems, in particular for the system for flooding.

The processing temperature for the wax can also be above 30° C. For many waxes, a particularly homogeneous and advantageous spray pattern is achieved in particular at 40° to 60°.

1. A preservation plant for vehicle bodies, having the following features:
a. the preservation plant is configured to discharge a waxy preservative into cavities and/or onto surfaces of a vehicle body, and
b. the preservation plant comprises at least
a storage tank for the preservative,
a discharging system for dispensing the preservative, and
a feed pump for feeding the preservative from the storage tank to the discharging system, and
c. the preservation plant comprises at least two discharging systems for dispensing the preservative, comprising:
a first discharging system, which is configured to discharge the preservative in a liquid form, and
a second discharging system, which is configured to discharge the preservative in an atomized form together with atomizing air (spray wax).

2. The preservation plant as claimed in claim 1, having the following feature:
a. the preservation plant comprises a common storage tank for supplying the first discharging system and the second discharging system.

3. The preservation plant as claimed in claim 1, having the following feature:
a. the preservation plant comprises a common feed pump for feeding the preservative from the storage tank to the first discharging system and to the second discharging system.

4. The preservation plant as claimed in claim 3, having the following features:
a. the preservation plant has a loop in which the common feed pump is provided and which has an inlet and an outlet, which are both connected to the storage tank, and
b. at least a first supply line for supplying the first discharging system and a second supply line for supplying the second discharging system branch off from the loop.

5. The preservation plant as claimed in claim 4, having the following feature:
a. at least one supply line has a further feed pump for supplying the associated discharging system.

6. The preservation plant as claimed in claim 1, having the following feature:
a. the first discharging system comprises a flood bar for positioning at a cavity to be flooded, having at least one outlet for the preservative.

7. The preservation plant as claimed in claim 1, having the following feature:
a. the second discharging system comprises at least one spray device which is supplied with atomizing air and preservative.

8. The preservation plant as claimed in claim 6, having the following feature:
a. the flood bar and/or the spray device are configured to be permanently or temporarily attached to a robot arm.

9. The preservation plant as claimed in claim 8, having the following feature:
a. the preservation plant has two robots for the simultaneous preservation of the body by means of the flood bar and by means of the spray device.

10. A method for preserving a vehicle body by introducing and/or applying a waxy preservative, including the following steps:
a. the vehicle body being delivered to a preservation plant as claimed in claim 1, and,
b. by means of the preservation plant, the vehicle body being preserved partially by flooding and partially by spraying.

11. The method as claimed in claim 10, having the following feature:
a. both the flooding and the spraying take place with a preserving wax which is flowable and sprayable at 30°.

12. The method as claimed in claim 11, having the following feature:
a. both the flooding and the spraying take place with a preservative which is at a temperature of between 20° C. and 60° C., preferably between 40° C. and 60° C., during discharging.

13. A vehicle body having the following feature:
a. the vehicle body has cavities and/or surfaces protected by the introduction or application of waxy preservative, and
b. the preservative was applied by means of the method as claimed in claim 10.
